(19) United States
(12) Patent Application Publication
(10) Pub. No.: US 2025/0301071 A1
(43) Pub. Date: Sep. 25, 2025

(54) PRINT SYSTEM AND METHOD AND NON-TRANSITORY COMPUTER READABLE MEDIUM

(71) Applicant: FUJIFILM Business Innovation Corp., Tokyo (JP)

(72) Inventors: Hisao KOMAZAWA, Kanagawa (JP); Akiho Yasuda, Kanagawa (JP)

(73) Assignee: FUJIFILM Business Innovation Corp., Tokyo (JP)

(21) Appl. No.: 18/787,108

(22) Filed: Jul. 29, 2024

(30) Foreign Application Priority Data
Mar. 25, 2024 (JP) 2024-048145

(51) Int. Cl. H04N 1/00

(52) U.S. Cl. CPC H04N 1/00082; H04N 1/00037; H04N 1/00074

(57) ABSTRACT

A print system includes a processor configured to: wait until multiple types of inspection in an inspection unit have been completed for a printed matter constituted by one page printed in a print unit; and cancel execution of a print job including the page if two or more types of abnormality are detected in the page and if operations which have been set for the detected two or more respective types of abnormality include a canceling operation for canceling the execution of a print job.

### CROSS-REFERENCE TO RELATED APPLICATIONS

This application is based on and claims priority under 35 USC 119 from Japanese Patent Application No. 2024-048145 filed Mar. 25, 2024.

### BACKGROUND

### (i) Technical Field

The present disclosure relates to a print system and method and a non-transitory computer readable medium.

### (ii) Related Art

Japanese Unexamined Patent Application Publication No. 2022-137718 discloses an inspection device. This inspection device inspects a printed matter output from an image forming unit for any inconvenience, based on a reading result of the printed matter, and switches a control operation to be performed for the image forming unit in accordance with the type of inconvenience.

Japanese Unexamined Patent Application Publication No. 2022-146528 discloses the following technology. It is possible to prevent the setting of a mode for switching an output unit to which a printed matter with a defect is output if this printed matter has a certain printing order.

Japanese Unexamined Patent Application Publication No. 2021-165020 discloses the following technology. The quality of a printed matter is inspected. Additionally, a first mode in which a sheet output unit is not switched regardless of an inspection result or a second mode in which a sheet output unit is switched in accordance with an inspection result is received. The sheet output unit to which the printed matter is output is controlled based on the received mode and the inspection result.

### SUMMARY

In a print system, multiple types of inspection are sequentially performed for a printed matter of each page of a print job, and also, the operation to be performed upon the occurrence of abnormality can be preset for each type of inspection. In the print system, however, when two or more types of abnormality are detected in one page, among the operations to be performed to handle the two or more types of abnormality, the operation to handle the abnormality which is first detected is preferentially executed.

There may be a case in which, for example, when two or more types of abnormality are detected in one page, if the operation to handle the abnormality detected later is first executed, the execution of the operation to handle the abnormality detected earlier may become unnecessary. In the print system, however, the operation to handle the abnormality detected earlier is preferentially executed. As a result, the number of pages to be printed in the print system per unit time may be reduced.

Aspects of non-limiting embodiments of the present disclosure relate to a print system and method and a non-transitory computer readable medium that can make it less likely to reduce the number of pages to be printed in the print system per unit time, compared with the configuration in which, when two or more types of abnormality are detected in one page, an operation to handle the abnormality detected earlier is preferentially executed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a print system including a processor configured to: wait until multiple types of inspection in an inspection unit have been completed for a printed matter constituted by one page printed in a print unit; and cancel execution of a print job including the page if two or more types of abnormality are detected in the page and if operations which have been set for the detected two or more respective types of abnormality include a canceling operation for canceling the execution of a print job.

### BRIEF DESCRIPTION OF THE DRAWINGS

An exemplary embodiment of the present disclosure will be described in detail based on the following figures, wherein:

FIG. 1 is a schematic view and diagram of a print system according to the exemplary embodiment;

FIG. 2 is a functional block diagram of a printer and a print server;

FIG. 3A illustrates an overview of an image inspection and a reading inspection;

FIG. 3B illustrates an overview of a registration inspection and a density inspection;

FIG. 4 illustrates an example of a setting screen for the density inspection and that for the registration inspection;

FIG. 5 is a flowchart illustrating print control processing executed by a print controller;

FIG. 6A illustrates examples of abnormality occurred in a page and examples of the operation to be performed to handle abnormality;

FIG. 6B illustrates an example of the relationships between operations to be performed to handle multiple types of abnormality and the operations to be selected;

FIGS. 7A through 7C illustrate examples of operations performed in the printer when the abnormality types shown in FIG. 6A have occurred; and

FIG. 8 illustrates a case in which the operation to be performed upon the occurrence of abnormality is switched from automatic recovery to user intervention when a failure to read at least one of a tone correction patch and a trim mark has occurred.

### DETAILED DESCRIPTION

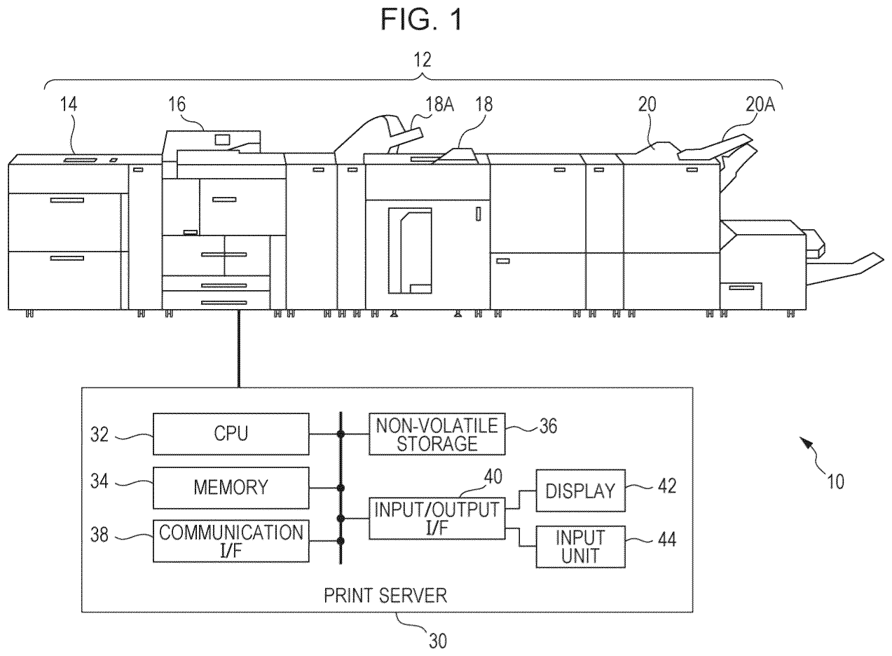

An example of an exemplary embodiment of the disclosure will be described below in detail with reference to the accompanying drawings. FIG. 1 is a schematic view and diagram of a print system 10 according to the exemplary embodiment. The print system 10 includes a printer 12 and a print server 30. The printer 12 includes a sheet feeder unit 14, a print unit 16, an inspection unit 18, and a sheet output unit 20.

Inside the sheet feeder unit 14, multiple sheets are set such that they are stacked on each other. The sheets stacked in the sheet feeder unit 14 are removed one by one starting from the topmost sheet by a sheet remover, which is not shown, and are sequentially sent to the print unit 16.

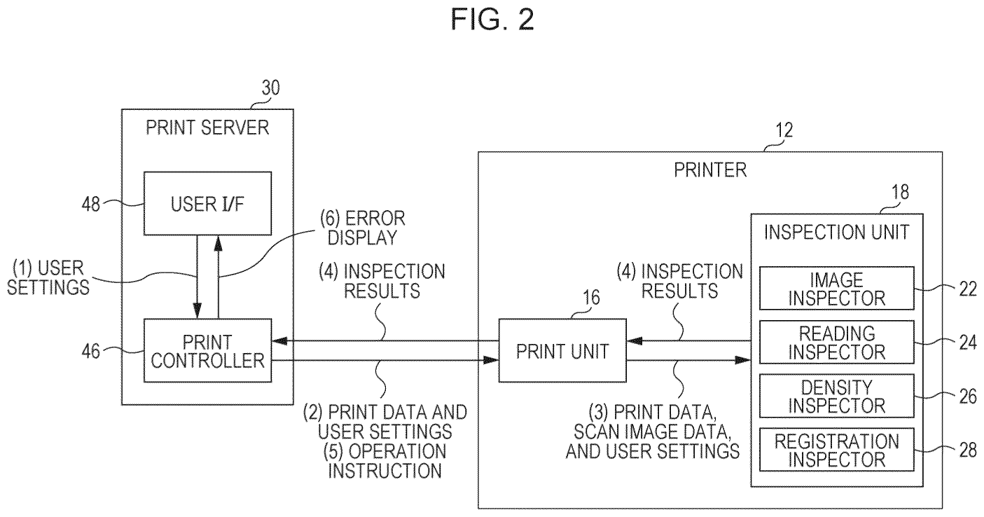

The print unit 16 prints an image on a sheet fed from the sheet feeder unit 14 by using an electrophotographic system or an inkjet method, for example. The print unit 16 receives image data to be printed on a sheet of a page as bitmap print data (also called raster image processor (RIP) data) from the print server 30 (also see (2) in FIG. 2). The print unit 16 also reads the image printed on a sheet with a scanner, which is not shown, and sends a reading result (scan image data) to the inspection unit 18, together with the print data (RIP data) (also see (3) in FIG. 2). The print unit 16 is an example of a print unit in an exemplary embodiment of the disclosure.

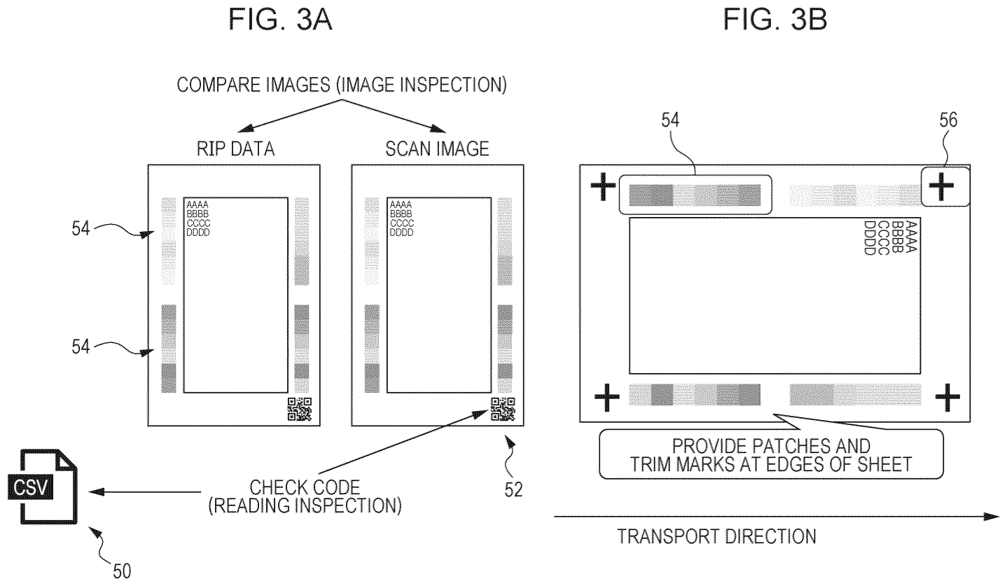

As illustrated in FIG. 2, the inspection unit 18 includes an image inspector 22, a reading inspector 24, a density inspector 26, and a registration inspector 28. Four types of inspection different from each other can be performed by the image inspector 22, reading inspector 24, density inspector 26, and registration inspector 28. As also shown in FIG. 3A, the image inspector 22 compares scan image data received from the print unit 16 with print data (RIP data) so as to inspect a printed image for any abnormality. The inspection unit 18 includes, for example, a central processing unit (CPU), a read only memory (ROM), a random access memory (RAM), and a storage, which are not shown. As a result of the CPU reading a program, the image inspector 22, reading inspector 24, density inspector 26, and registration inspector 28, which form the functional configuration of the inspection unit 18, are implemented.

In the exemplary embodiment, the print unit 16 receives verification data (csv-format data 50 shown in FIG. 3A, for example) to be printed on a sheet of each page from the print server 30, together with print data and prints a barcode (also see a barcode 52 shown in FIG. 3A) represented by the verification data on the corresponding page. The barcode printed on one page is different from that on another page. As also shown in FIG. 3A, the reading inspector 24 reads the barcode 52 from the scan image data and compares the read barcode 52 with the verification data so as to inspect the printed image for any abnormality, such as the omission of pages.

In the exemplary embodiment, the print unit 16 prints a tone correction patch 54 of each of the CMYK colors at an edge portion of each page, as shown in FIG. 3B. The density inspector 26 identifies the density (tone) of the tone correction patch 54 from the scan image data so as to inspect the printed image for density abnormality, such as density (tone) deviation. The tone correction patch 54 is an example of a first mark for tone correction in an exemplary embodiment of the disclosure.

In the exemplary embodiment, the print unit 16 prints a trim mark 56 for registration adjustment at a predetermined position at an end of a sheet, as shown in FIG. 3B. The registration inspector 28 identifies the position of a sheet at which the trim mark 56 is printed from the scan image data so as to inspect the printed image for any abnormality, such as misregistration. The trim mark 56 is an example of a second mark for registration adjustment in an exemplary embodiment of the disclosure.

In the inspection unit 18, the image inspector 22, reading inspector 24, density inspector 26, and registration inspector 28 are arranged so that the inspection operations of the image inspector 22, reading inspector 24, density inspector 26, and registration inspector 28 are performed in a certain order for a sheet of a page on which an image is printed in the print unit 16. Additionally, in the exemplary embodiment, it is possible to preset for each type of inspection whether to perform inspection, which will be discussed later. The inspection unit 18 performs individual types of inspection, which have been set to be executed, for a sheet of each page and also sends the inspection result of each page to the print unit 16. The print unit 16 transfers the inspection result received from the inspection unit 18 to the print server 30 (also see (4) in FIG. 2).

The inspection unit 18 also includes a purge tray 18A (see FIG. 1). In the exemplary embodiment, it is possible to preset for each type of inspection whether to output a page (sheet) in which abnormality has occurred as a result of performing inspection to the purge tray 18A. This will be discussed later. When abnormality has occurred in a certain page (sheet), this page is output to the purge tray 18A if the above-described setting has set for the type of inspection corresponding to this abnormality. The inspection unit 18 is an example of an inspection unit in an exemplary embodiment of the disclosure.

The sheet output unit 20 includes a sheet output tray 20A (see FIG. 1). A sheet on which an image is printed in the print unit 16 and which is not output to the purge tray 18A of the inspection unit 18 is output to the sheet output tray 20A of the sheet output unit 20 and is sequentially stacked.

The print server 30 includes a CPU 32, a memory 34, such as a ROM and a RAM, a non-volatile storage 36, such as a hard disk drive (HDD) and a solid state drive (SSD), a communication interface (I/F) 38, and an input/output I/F 40. The CPU 32, memory 34, non-volatile storage 36, communication I/F 38, and input/output I/F 40 are connected to each other via a bus. A display 42 and an input unit 44, such as a keyboard, are connected to the input/output I/F 40.

In the non-volatile storage 36 of the print server 30, a print control program is stored. As a result of the print control program being read from the non-volatile storage 36, being loaded into the memory 34, and being executed by the CPU 32, the print server 30 is implemented as a print controller 46 shown in FIG. 2. The CPU 32 is an example of a processor in an exemplary embodiment of the disclosure.

The print controller 46 waits until multiple types of inspection in the inspection unit 18 have been completed for a printed matter constituted by one page printed in the print unit 16. If two or more types of abnormality are detected in this page and if operations which have been set for the detected two or more types of abnormality include a canceling operation for canceling the execution of a print job, the print controller 46 cancels the execution of the print job including this page. A user I/F 48 shown in FIG. 2 is constituted by the display 42 and the input unit 44.

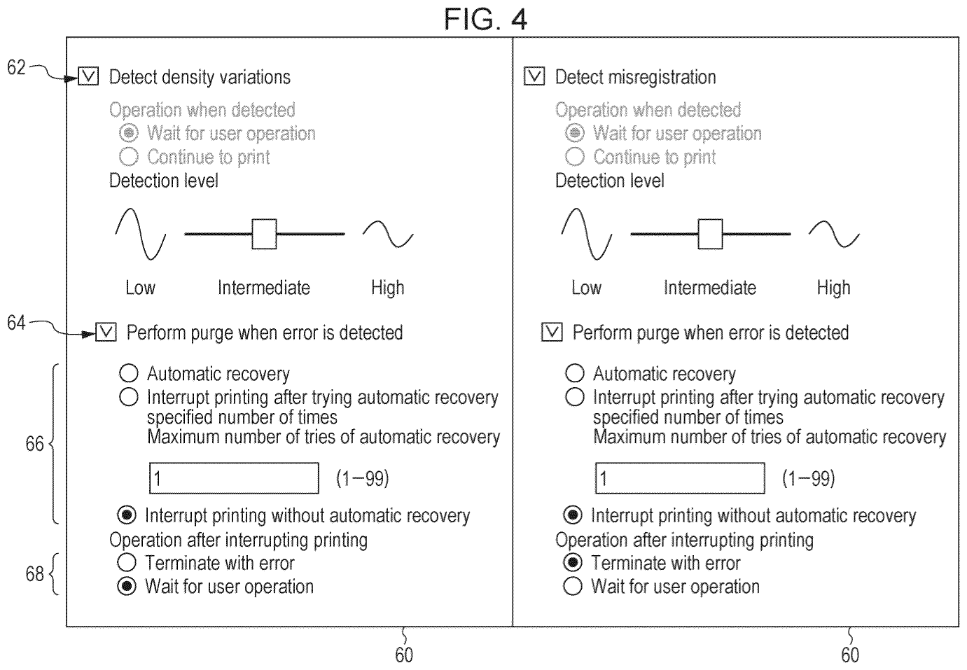

When information for calling settings regarding inspection to be performed by the inspection unit 18 is input via the input unit 44 of the user I/F 48, the print controller 46 performs control to display a setting screen 60, such as that shown in FIG. 4, on the display 42 of the user I/F 48, as an example. In FIG. 4, the setting screen 60 regarding the density inspection to be performed by the density inspector 26 and the setting screen 60 regarding the registration inspection to be performed by the registration inspector 28 are shown. A similar setting screen is also prepared for each of the image inspection to be performed by the image inspector 22 and the reading inspection to be performed by the reading inspector 24.

In the setting screen 60, a first check box 62 is provided to set whether to execute a corresponding type of inspection. In the exemplary embodiment, when the first check box 62 is checked by a user, the inspection unit 18 executes the corresponding inspection. In the setting screen 60, a second check box 64 is also provided to set whether to output a sheet with abnormality having occurred and detected in a corresponding type of inspection to the purge tray 18A of the inspection unit 18. In the exemplary embodiment, when the second check box 64 is checked by a user, a sheet with abnormality having occurred and detected in a corresponding type of inspection is output to the purge tray 18A of the inspection unit 18. Hereinafter, outputting a sheet in which abnormality has occurred to the purge tray 18A may also be called a purge operation.

In the setting screen 60, radio buttons 66 are also provided to mutually exclusively select one of the following options when the second check box 64 is checked: reprinting (automatic recovery); interrupting a print job after performing reprinting a specified number of times; and immediately interrupting a print job. In the setting screen 60, radio buttons 68 are also provided to mutually exclusively select one of the following options as the operation to be performed after a print job is interrupted: terminating (canceling) a print job; and waiting for a user operation (user intervention). As a result of selecting one of the radio buttons 66 and one of the radio buttons 68, one of the following options: “automatic recovery”; “canceling without automatic recovery”; and “user intervention without automatic recovery”, is mutually exclusively set as the operation to be performed upon the occurrence of abnormality.

When the user has input inspection settings on the setting screen 60, the input settings are output from the user I/F 48 to the print controller 46 (also see (1) in FIG. 2) and are then transferred from the print controller 46 to the inspection unit 18 via the print unit 16 (also see (2) and (3) in FIG. 2).

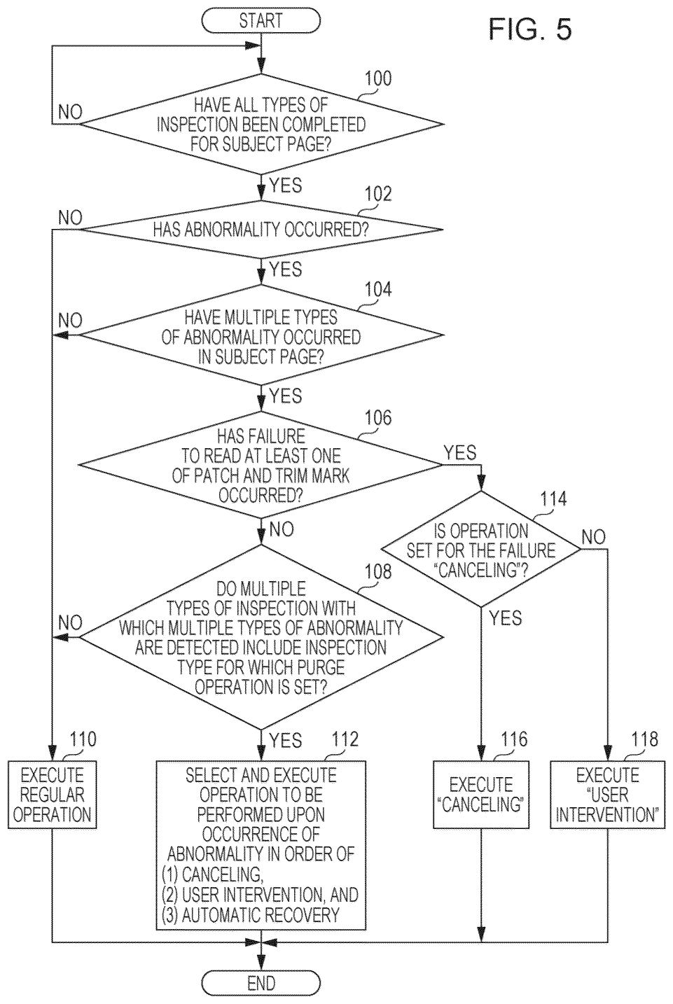

Print control processing executed by the print controller 46 when the printer 12 prints an image on a sheet will be described below with reference to FIG. 5 as the operation of the exemplary embodiment. This print control processing is executed for each page of a print job which is being executed by the printer 12.

In step 100 in FIG. 5, the print controller 46 determines whether all the types of inspection that are set to be executed have been completed for one page (sheet) to be processed in the inspection unit 18. Hereinafter, a page to be subjected to print control processing will be called a subject page. If the result of step 100 is NO, step 100 is repeated until the result of step 100 becomes YES.

If the result of step 100 is YES, the print controller 46 proceeds to step 102 to determine whether abnormality has been detected in the subject page by the inspection of the inspection unit 18. If the result of step 102 is NO, the print controller 46 proceeds to step 110. In step 110, the print controller 46 performs control to execute a regular operation. For example, the print controller 46 causes the inspection unit 18 to output the subject page to the sheet output unit 20. The print controller 46 then terminates the print control processing.

If the result of step 102 is YES, the print controller 46 proceeds to step 104 to determine whether multiple types of abnormality have occurred in the subject page. If only one type of abnormality has occurred in the subject page, the result of step 104 becomes NO and the print controller 46 proceeds to step 110. In step 110, the print controller 46 performs control to execute a certain operation to handle the detected type of abnormality as the regular operation. For example, if the execution of a purge operation is set, the print controller 46 causes the inspection unit 18 to perform one of the operations: “automatic recovery”; “canceling”; and “user intervention”. The print controller 46 then terminates the print control processing.

If multiple types of abnormality have occurred in the subject page, the result of step 104 becomes YES and the print controller 46 proceeds to step 106. In step S106, the print controller 46 determines whether the inspection types that are set to be executed include at least one of the density inspection and the registration inspection and whether at least one of the tone correction patch 54 and the trim mark 56 has not been detected in at least one of the executed density inspection and registration inspection, in other words, whether a failure to read at least one of the tone correction patch 54 and the trim mark 56 has occurred.

If the result of step 106 is NO, the print controller 46 proceeds to step 108. In step 108, the print controller 46 determines whether the multiple types of inspection with which the multiple types of abnormality are detected in the subject page include an inspection type for which the execution of a purge operation is set. If the result of step 108 is NO, that is, if the execution of a purge operation is not set for any of the multiple types of inspection, the print controller 46 proceeds to step 110. In step 110, the print controller 46 performs control to execute a regular operation. For example, the print controller 46 causes the inspection unit 18 to output the subject page to the sheet output unit 20.

If the result of step 108 is YES, that is, if the multiple types of inspection with which the multiple types of abnormality are detected in the subject page include an inspection type for which the execution of a purge operation is set, the print controller 46 proceeds to step 112. In step 112, among the operations corresponding to the multiple types of inspections, the print controller 46 selects one of the operations in accordance with a predetermined priority and executes the selected operation.

In the exemplary embodiment, as the operations to be performed upon the occurrence of abnormality, (1) canceling, (2) user intervention, and (3) automatic recovery are set in order of high to low priority. With this priority setting, if the operations to be performed upon the occurrence of abnormality corresponding to the multiple types of inspection include “canceling”, the print controller 46 selects and executes “canceling”.

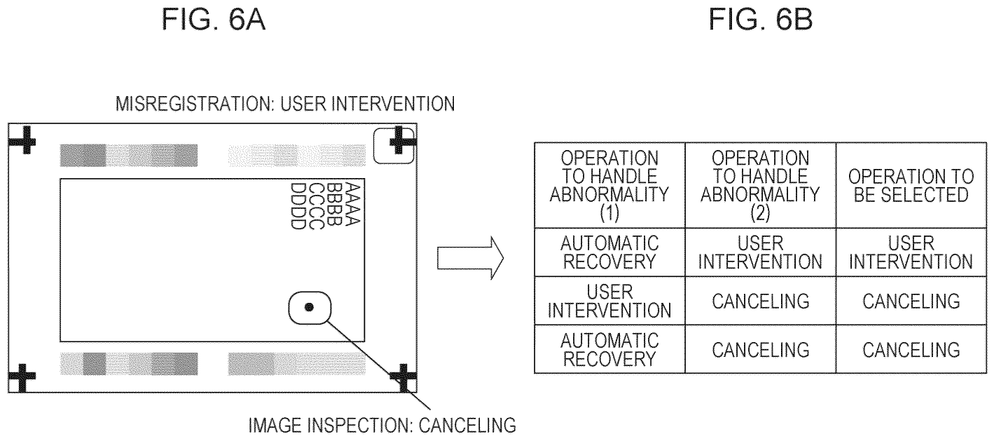

For example, the following first case will be considered. In the first case, “misregistration (occurrence of abnormality in the registration inspection)” and “image abnormality (occurrence of abnormality in the image inspection)” have occurred in a subject page, as shown in FIG. 6A. As the operation to be performed upon the occurrence of abnormality, “user intervention” is set for the registration inspection, while “canceling” is set for the image inspection. The first case corresponds to the case in the second row in the table in FIG. 6B, and “canceling” having a higher priority is selected and executed as the operation to be performed.

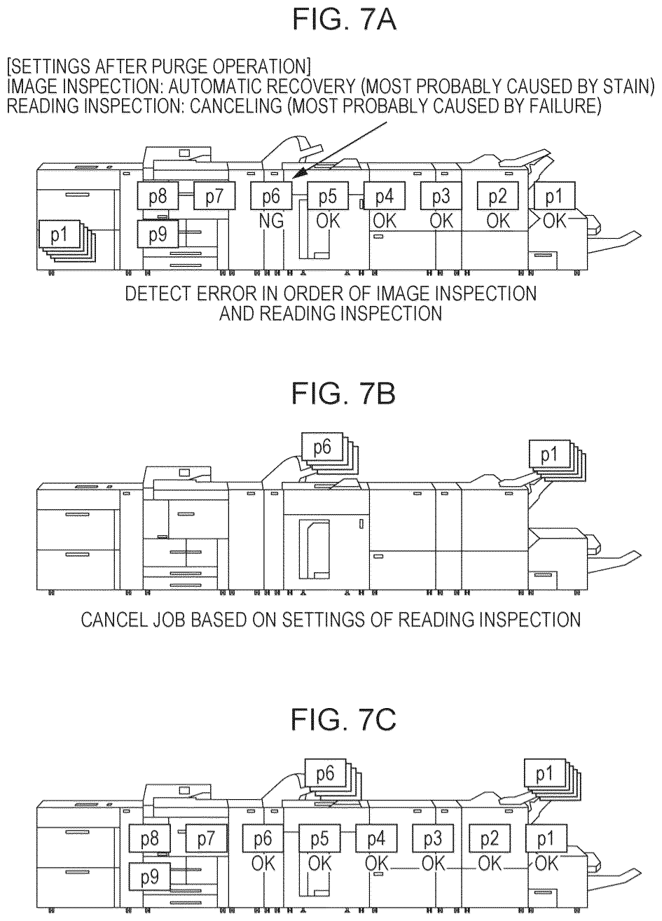

More specifically, it is assumed that, in the first case, the page in which “misregistration” and “image abnormality” have occurred and detected by the inspection of the inspection unit 18 is the sixth page of a first print job, as shown in FIG. 7A, and, at this time, pages up to the ninth page of the first print job have been printed. Then, as a result of selecting and executing “canceling”, printing of the tenth and subsequent pages of the first print job is canceled, and the sixth through ninth pages of the first print job are output to the purge tray 18A, as shown in FIG. 7B. Then, a second print job subsequent to the first print job is executed, as shown in FIG. 7C.

In another example, the following second case will be considered. In the second case, a first abnormality and a second abnormality have occurred in a subject page and, as the operation to be performed upon the occurrence of abnormality, “automatic recovery” is set for the inspection type with which the first abnormality is detected, while “canceling” is set for the inspection type with which the second abnormality is detected. The second case corresponds to the case in the third row in the table in FIG. 6B, and “canceling” having a higher priority is selected and executed as the operation to be performed.

As described above, when the operations to be performed corresponding to multiple types of inspection with which multiple types of abnormality are detected include “canceling”, “canceling” is selected and executed. With this configuration, the number of pages to be printed in the printer 12 per unit time may be less likely to be reduced.

When the operations to be performed corresponding to multiple types of inspection with which multiple types of abnormality are detected in a subject page do not include “canceling” but include “user intervention”, “user intervention” is selected and executed as the operation to be performed upon the occurrence of abnormality.

For example, the following third case will be considered. In the third case, a first abnormality and a second abnormality have occurred in a subject page and, as the operation to be performed upon the occurrence of abnormality, “automatic recovery” is set for the inspection type with which the first abnormality is detected, while “user intervention” is set for the inspection type with which the second abnormality is detected. The third case corresponds to the case in the first row in the table in FIG. 6B, and “user intervention” having a higher priority is selected and executed as the operation to be performed. A user is informed of the occurrence of abnormality via the user I/F 48, and the print controller 46 waits for an operation from the user. With this configuration, wasteful printing may be reduced.

If a failure to read at least one of the tone correction patch 54 and the trim mark 56 has occurred, the result of step 106 becomes YES and the print controller 46 proceeds to step 114. In step 114, the print controller 46 determines whether the operation set for the inspection type with which a failure to read at least one of the tone correction patch 54 and the trim mark 56 is detected is “canceling”. If the result of step 114 is YES, the print controller 46 proceeds to step 116. In step 116, the print controller 46 executes “canceling” as the operation to be performed upon the occurrence of abnormality.

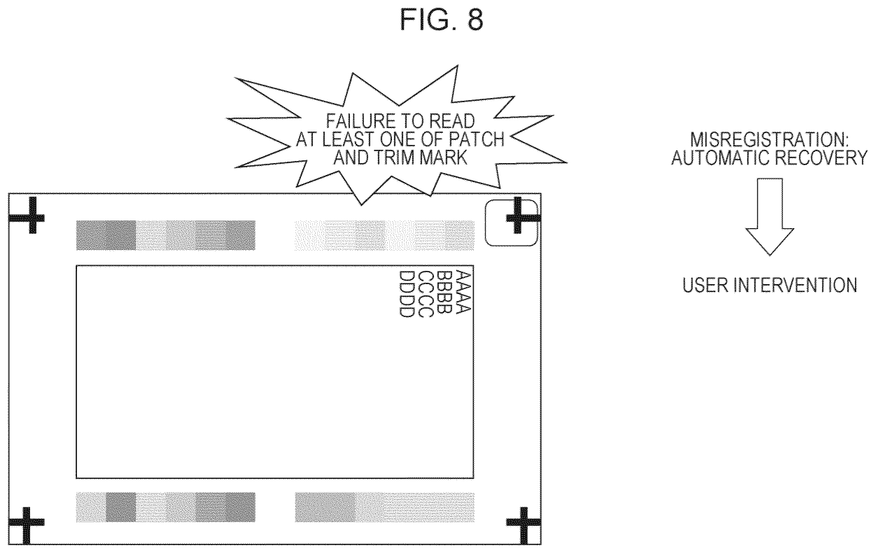

If the result of step 114 is NO, the print controller 46 proceeds to step 118. In step 118, the print controller 46 executes “user intervention” as the operation to be performed upon the occurrence of abnormality. With this operation, as illustrated in FIG. 8, if a failure to read at least one of the tone correction patch 54 and the trim mark 56 has occurred and if, as the operation to be performed, “automatic recovery” is set for the inspection type with which this failure is detected, the operation to be performed is switched from “automatic recovery” to “user intervention”. With this configuration, wasteful printing that is unable to guarantee at least one of the tone and the registration is less likely to be performed.

As described above, in the exemplary embodiment, the print controller 46 waits until multiple types of inspection in the inspection unit 18 have been completed for a printed matter constituted by one page printed in the print unit 16. If two or more types of abnormality are detected in this page and if operations which have been set for the detected two or more types of abnormality include “canceling” for canceling the execution of a print job, the print controller 46 cancels the execution of a print job including this page. With this configuration, the number of pages to be printed in the print system 10 per unit time may be less likely to be reduced, compared with the configuration in which, when two or more types of abnormality are detected in one page, an operation to handle the abnormality detected earlier is preferentially executed.

In the exemplary embodiment, if two or more types of abnormality are detected in one page and if operations which have been set for the detected two or more types of abnormality do not include “canceling” but include “user intervention” for waiting for a user operation, the print controller 46 informs the user of the occurrence of abnormality and waits for an operation to be performed by the user. With this configuration, if two or more types of abnormality are detected in one page and if operations which have been set for the detected two or more types of abnormality do not include “canceling”, the execution of wasteful printing may be reduced.

In the exemplary embodiment, if two or more types of abnormality are detected in one page and if the detected two or more types of abnormality include a failure to read at least one of the tone correction patch 54 and the trim mark 56 printed in this page and if the operation set for the abnormality in which this failure has occurred is “canceling”, the print controller 46 cancels the execution of a print job including this page. With this configuration, when a failure to read at least one of the tone correction patch 54 and the trim mark 56 has occurred, wasteful printing that is unable to guarantee at least one of the tone and the registration may be less likely to be performed.

In the exemplary embodiment, if two or more types of abnormality are detected in one page and if the detected two or more types of abnormality include a failure to read at least one of the tone correction patch 54 and the trim mark 56 printed in this page and if the operation which has been set for the abnormality in which this failure has occurred is an operation other than “canceling”, the print controller 46 informs a user of the occurrence of abnormality and waits for an operation to be performed by the user. With this configuration, when a failure to read at least one of the tone correction patch 54 and the trim mark 56 has occurred, wasteful printing that is unable to guarantee at least one of the tone and the registration may be less likely to be performed.

In the above-described exemplary embodiment, the print control processing shown in FIG. 5 is executed by the print server 30 (print controller 46). However, the disclosure is not limited to this configuration. The print control processing may be executed by the inspection unit 18 or the print unit 16.

In the above-described exemplary embodiment, the print control program, which is an example of a program of an exemplary embodiment of the disclosure, is stored (installed) in the non-volatile storage 36. However, the print control program may be provided as a result of being stored in a non-transitory recording medium, such as an HDD, an SSD, or a digital versatile disc (DVD).

The above-described print control processing may be executed by a dedicated hardware circuit. In this case, the print control processing may be executed by one hardware unit or plural hardware units.

A program for operating the print system 10 may be provided as a result of being recorded on a computer readable recording medium, such as a universal serial bus (USB) memory, a flexible disk, and a compact disc—read only memory (CD-ROM), or may be provided online via a network, such as the internet. The program recorded on a computer readable recording medium is typically transferred to a memory or a storage, for example, and is stored. The program may be provided as application software or be integrated into software of the print system 10 as one function of the print system 10.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### (Appendix)

(((1)))

A print system comprising:
a processor configured to:
   wait until a plurality of types of inspection in an inspection unit have been completed for a printed matter constituted by one page printed in a print unit; and cancel execution of a print job including the page if two or more types of abnormality are detected in the page and if operations which have been set for the detected two or more respective types of abnormality include a canceling operation for canceling the execution of a print job.
      (((2)))

The print system according to (((1))), wherein the processor is configured to inform a user of an occurrence of abnormality and wait for a user operation if two or more types of abnormality are detected in the page and if operations which have been set for the detected two or more respective types of abnormality do not include the canceling operation but include a user intervention operation for waiting for a user operation.

(((3)))

The print system according to (((1))) or (((2))), wherein the processor is configured to cancel the execution of the print job including the page if two or more types of abnormality are detected in the page and if the detected two or more types of abnormality include a failure to read at least one of a first mark and a second mark printed in the page, the first mark being used for tone correction, the second mark being used for registration adjustment, and if the operation set for the abnormality in which the failure has occurred is the canceling operation.

(((4)))

The print system according to (((3))), wherein the processor is configured to inform a user of an occurrence of abnormality and wait for a user operation if two or more types of abnormality are detected in the page and if the detected two or more types of abnormality include a failure to read at least one of the first mark and the second mark printed in the page and if the operation set for the abnormality in which the failure has occurred is an operation other than the canceling operation.

(((5)))

A program causing a computer to execute a process, the process comprising:
waiting until a plurality of types of inspection in an inspection unit have been completed for a printed matter constituted by one page printed in a print unit; and
canceling execution of a print job including the page if two or more types of abnormality are detected in the page and if operations which have been set for the detected two or more respective types of abnormality include a canceling operation for canceling the execution of a print job.

What is claimed is:

1. A print system comprising:
a processor configured to:
wait until a plurality of types of inspection in an inspection unit have been completed for a printed matter constituted by one page printed in a print unit; and
cancel execution of a print job including the page if two or more types of abnormality are detected in the page and if operations which have been set for the detected two or more respective types of abnormality include a canceling operation for canceling the execution of a print job.

2. The print system according to claim 1, wherein the processor is configured to inform a user of an occurrence of abnormality and wait for a user operation if two or more types of abnormality are detected in the page and if operations which have been set for the detected two or more respective types of abnormality do not include the canceling operation but include a user intervention operation for waiting for a user operation.

3. The print system according to claim 1, wherein the processor is configured to cancel the execution of the print job including the page if two or more types of abnormality are detected in the page and if the detected two or more types of abnormality include a failure to read at least one of a first mark and a second mark printed in the page, the first mark being used for tone correction, the second mark being used for registration adjustment, and if the operation set for the abnormality in which the failure has occurred is the canceling operation.

4. The print system according to claim 3, wherein the processor is configured to inform a user of an occurrence of abnormality and wait for a user operation if two or more types of abnormality are detected in the page and if the detected two or more types of abnormality include a failure to read at least one of the first mark and the second mark printed in the page and if the operation set for the abnormality in which the failure has occurred is an operation other than the canceling operation.

5. A print method comprising:
waiting until a plurality of types of inspection in an inspection unit have been completed for a printed matter constituted by one page printed in a print unit; and
canceling execution of a print job including the page if two or more types of abnormality are detected in the page and if operations which have been set for the detected two or more respective types of abnormality include a canceling operation for canceling the execution of a print job.

6. A non-transitory computer readable medium storing a program causing a computer to execute a process, the process comprising:
waiting until a plurality of types of inspection in an inspection unit have been completed for a printed matter constituted by one page printed in a print unit; and
canceling execution of a print job including the page if two or more types of abnormality are detected in the page and if operations which have been set for the detected two or more respective types of abnormality include a canceling operation for canceling the execution of a print job.
